(19) United States
(12) Patent Application Publication
(10) Pub. No.: US 2020/0163361 A1
(43) Pub. Date: May 28, 2020

(54) ANIMAL FOODSTUFF AND METHOD OF MANUFACTURE

(71) Applicant: Silvermoor Equestrian Haylage Limited, Alnwick (GB)

(72) Inventor: Ralph Thompson, Alnwick (GB)

(73) Assignee: Silvermoor Equestrian Haylage Limited, Alnwick (GB)

(21) Appl. No.: 16/611,853

(22) PCT Filed: May 10, 2018
(86) PCT No.: PCT/GB2018/051268

§ 371 Date: Nov. 8, 2019

(30) Foreign Application Priority Data
May 11, 2017 (GB) 1707582.1

(51) Int. Cl. A23K 10/30; A23K 50/20; A23K 40/20; A23K 20/174

(52) U.S. Cl. CPC A23K 10/30; A23K 20/174; A23K 40/20; A23K 50/20

(57) ABSTRACT

The present invention relates to an animal foodstuff and a method for manufacturing the same. In a preferred variat the invention relates to an equine foodstuff. More particularly the invention relates to a hangable, low sugar, forage based foodstuff for horses in the form of forage combined with an edible binder to give a block of forage based edible material and a means that permits suspension of said block of forage based edible material from a suitable suspension point.

The present invention relates to a domestic animal, more preferably a farm animal, foodstuff and a method for manufacturing the same. A preferred embodiment of the invention relates to an equine foodstuff and the invention relates to a hangable, low sugar, forage based foodstuff for horses.

Forage feed is important in a horses diet as it provides a horse with the fibre necessary to keep the horse's digestive system functioning properly. Generally, a horse should have access to forage feed through much of the day and night and in a standard diet forage feed should make up at least half, preferably all, of a horse's daily intake of food. On average a horse is anticipated to consume 7.5 kg per day.

Obviously when able to freely graze a horse is able to obtain the forage they require, however when stabled or otherwise restricted in movement forage is typically provided in loose form or occasionally in nets. Whilst this provides a source of forage for the horse, it can lead to issues that it is too easily available and horses can have a tendency to overgraze or eat too rapidly. Horses can also become bored when stabled or otherwise restricted and this can exacerbate the overeating or eating too quickly.

Various attempts have been made to provide equine foodstuff that can reduce overeating and/or assist with reducing boredom. For example, the forage can be placed in nets to reduce the access to the horse that can be somewhat effective but doesn't provide either enough limitation or interest to the horse.

GB2520490 describes a block of compressed forage with vitamin/mineral supplements and a weight of between 0.5 and 1.5 kg. The compression of the block provides some additional work for the horse when eating, however there is a tendency for the blocks to be pushed into a corner by a horse which allows them to again consume it very rapidly (as such the blocks are often still placed in nets) and once the horse begins eating the integrity of the compressed block breaks down fairly rapidly.

GB2480007 describes a horse lick holder that can be used to prevent boredom. The holder has an outer frame that can be hung up and is filled with a lickable substance such as molasses or salt composition that that a horse can lick. The outer frame prevents the horse getting significant access to the product such that it is forced to lick it. Whilst appropriate for occasional treats the high sugar content of the lickable substance is not a healthy option and the product is really only appropriate for treats rather than feed.

There are also a number of treats or clicks' that can be used to try to prevent boredom. However, these are not forage based and tend to be seed based or similar and also are very high in sugar as they are bound using syrups and similar sugary contents which encourage licking of the product rather than simply slowing the eating—hence their use a treats rather than feed.

Other domesticated animals including fowl such as chickens can also use forage in their diet, and again high sugar is not ideal.

The present invention aims to obviate or mitigate one or more of the problems associated with the prior art.

Throughout this document the term ‘forage’ refers to grass and legume plant material eaten by grazing livestock—this includes grasses, hays, herbaceous legumes, tree legumes, silage (where grasses and legumes are chopped wet and fermented) and crop residues. As would be understood by those skilled in the art, the term forage does not encompass seeds, grains and nuts.

The term ‘edible’ in this document relates to materials that can be safely eaten by horses and other domesticated animals.

According to a first aspect of the present invention there is provided an animal foodstuff comprising;

forage combined with an edible binder to give a substantially solid block of forage based edible material; and
means for associating the block of forage based edible material with an elongate hanging element, such that at least a portion of the elongate element is associated with and extends from the block of forage based edible material in a manner that permits suspension of said block of forage based edible material from a suitable suspension point.

Preferably animal foodstuff further comprisies;

an elongate hanging element, at least a portion of which is associated with and extends from the block of forage based edible material in a manner that permits suspension of said block of forage based edible material from a suitable suspension point.

Preferably the animal foodstuff is an equine foodstuff.

Optionally the animal foodstuff is an equine, ruminant or avian foodstuff.

Preferably the forage is selected from on or more of grasses, hays, herbaceous legumes, tree legumes, silage and crop residues.

Advantageously the suspension point may be on a stable wall or ceiling to allow the feed to be freely suspended.

Preferably the binder is a lignin-based binder, more preferably lignosulphonate.

Advantageously, the liquid form of lignosulphonate is 50% solid and as such when used as a binder the amount of water or moisture present in the end product is minimised. This reduces mould.

Preferably the binder is present in quantities between 5% and 15%.

It has been found that insufficient binder results in a block with insufficient structural integrity and too much binder can result in excess moisture in the product that reduces shelf life and can result in mould.

Most preferably the binder is present at 10%.

Preferably the block of forage based edible material has rounded outer edges.

Preferably the block of forage based edible material is cylindrical in shape. Optionally at least one of the ends of the cylinder is substantially domed.

Advantageously by providing the block of forage based edible material in a shape with substantially rounded edges or minimal corners it is more challenging for an animal such as a horse to either gain purchase or press the block of forage based edible material against a surface to prevent movement. This increases the interest for the horse and reduces the speed at which the block of forage based edible material is consumed.

Optionally the elongate hanging element extends through the block of forage based edible material and is secured at least at one end.

Optionally the block of forage based edible material is provided with a through bore through which the elongate hanging element may pass.

Optionally the elongate hanging element is provided with a stop means at one end that is unable to pass through the bore.

Optionally the bore passes through the centre of the block of forage based edible material.

Alternatively one end of the elongate hanging element is embedded in the substantially solid block of forage based edible material.

Optionally the elongate hanging element is a rope. The rope may have a knot or other stop means at or towards one end.

According to an aspect of the present invention there is provided a method of manufacturing an animal foodstuff in the form of a block of forage based edible material comprising;

providing an edible binder in liquid form;
adding said binder substantially uniformly to a forage material such that it is substantially evenly distributed throughout the forage; and
compressing the material into the desired shape to give a block of forage based edible material.

Preferably the animal foodstuff is an equine foodstuff.

Optionally the animal foodstuff is an equine, ruminant or avian foodstuff.

Preferably the forage material is one or more of grasses, hays, herbaceous legumes, tree legumes, silage (where grasses and legumes are chopped wet and fermented) and crop residues.

Preferably the binder is a lignin-based binder, more preferably lignosulphonate

Optionally, the binder is heated prior to being added to the forage material.

Most preferably the binder is heated to between 30° C. and 40° C. prior to being added to the forage material.

Advantageously heating the binder means that it can be sprayed over the forage, ideally whilst the forage is being mixed, to given an even distribution of the binder through the material.

Preferably, the material is compressed into the desired shape using a mould, The mould contains an appropriately shaped are to create an aperture of an appropriate size to receive an elongate hanging element in the resulting compressed block of forage based edible material. Preferably, an elongate hanging element is then passed through the aperture in a manner such that the block of forage based edible material can be suspended via the elongate hanging element.

Optionally, after the material has been compressed into the desired shape, an aperture of an appropriate size to receive an elongate hanging element is created in the block of forage based edible material. Preferably, an elongate hanging element is then passed through the aperture in a manner such that the block of forage based edible material can be suspended via the elongate hanging element.

Alternatively, before the material has been compressed into the desired shape, or during compression of the material, an elongate hanging element is embedded into the forage such that a portion is within the material and a portion extends therefrom.

Preferably the binder is present in quantities between 5% and 20%. More preferably between 5 and 15%.

Most preferably the binder is present at 10%.

Optionally the compression occurs in a shaped mold.

Preferably the desired shape has rounded outer edges.

Preferably the desired shape is substantially that of a cylinder.

Optionally at least one of the ends of the cylinder is substantially domed.

In order to provide a better understanding of the present invention an embodiment will now be described, by way of example only, and with reference to the following Figures;

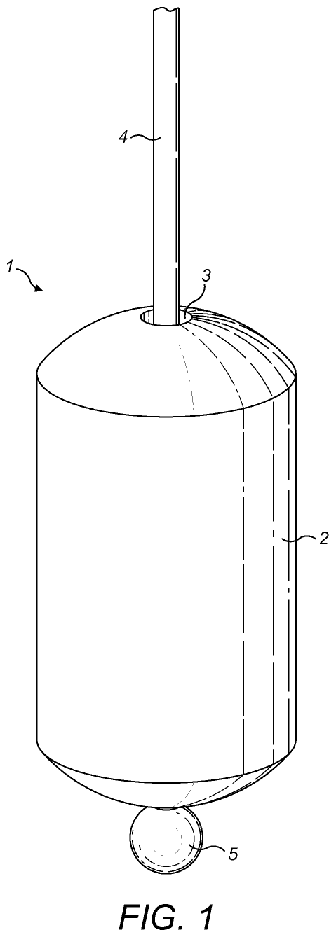

FIG. 1 is a diagram showing a hangable horse feed product according to a preferred embodiment of the present invention; and

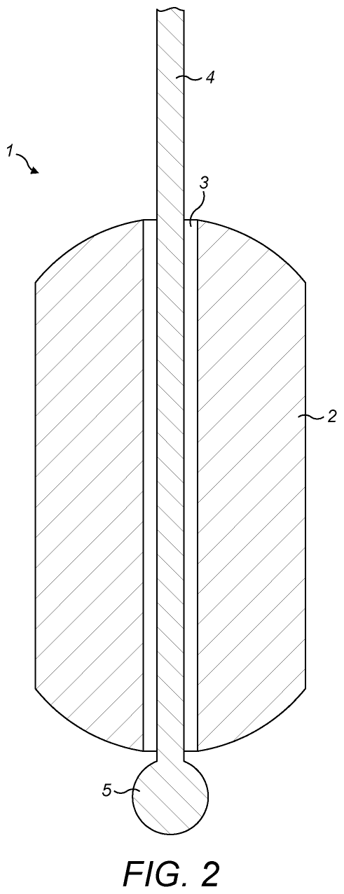

FIG. 2 is a cross section of FIG. 1.

A forage based horse food 1 in accordance with the present invention is generally depicted in FIG. 1. The food is in the form of a substantially solid block of forage 2 such as grass, lucerne or alfalfa. Further additives such as vitamins and minerals could be added to the forage, as could other additional such as dried fruit etc. The material also includes a binder, which in this embodiment is lignosulfonate. Other suitable binder materials may be utilised, as will be appreciated by those skilled in the art. However, the binders are generally elected to be low in sugars and to have a relatively low water content in their liquid form e.g. a water content of 50% or less water. The binder is present as 10% of the material. For example, in a block with approximately 1 kg of grass the would be approximately 100 g of binder present.

A preferred method for manufacturing the solid block of forage comprises the following steps;
Warm the lignin sulfonate binder to between 30-40° C.
Weigh out dried grass
Tip the dried grass into a mixer and start mixing
Measure out warmed binder to 10% binder 90% grass
Spray gradually the warmed binder into mixer while continually mixing to insure an even coverage of the grass with the binder
Allow to mix for 5 minutes once all binder has been added
Transfer 1 kg of the mixture into a mold the mold contains a portion that results in the final block having an aperture or bore therethrough.
Compress mixture to a pressure of 3000 psi with 40t
Remove block out of mold
Package block

In alternative embodiments the mould is not shaped to provide an aperture or bore and instead the bore is drilled or cut in the material after the block is removed from the mould.

The solid block of forage 2 is substantially cylindrical in shape, with the ends of the cylinder having rounded or domed shape. In alternative embodiments the block is spherical. Other shapes could be used as will be appreciated by those skilled in the art. As is best seen in FIG. 2, a central aperture or bore 3 is provided longitudinally through the cylindrical block 2. A rope 4 is passed through the aperture/bore 3 such that one ends out beyond the bock 2 and can be attached to an appropriate suspension point. The other end is provided with a knot 5 which itself is larger than the diameter of the bore. In alternative embodiments there may be a disc, bead or other stop element that acts to prevent the end of the rope 4 passing the aperture/bore 3.

It will be appreciated that any appropriate rope could be used providing it is able to withstand the weight of an appropriately sized (e.g. 0.5 to 1.5 kg, although other sized blocks could be envisaged) block of feed. Further, although this embodiment uses rope any alternative means for hanging can be used. It is generally preferred that the elongate hanging element allow flexibility of movement to increase the challenge to the horse when feeding, however substantially rigid elongate elements could also be used.

It is also envisaged that the block 2 with through aperture could be provided separately to the rope or other elongate hanging element for the end user to thread onto the rope when ready for use.

A lucerne (legume) based avian foodstuff is also envisaged. This is produced similarly to the horse feed and again is low in sugar. This product can be made by carrying out the following steps;
Weigh out dried lucerne
Tip the dried lucerne into a mixer and start mixing
Measure out warmed binder to 10% binder 90% lucerne
Spray gradually the warmed binder into mixer while continually mixing to insure an even coverage of the lucerne with the binder
Allow to mix for a minimum of one hour once all binder has been added
Transfer 1 kg of the mixture into a mold—the mold contains a portion that results in the final block having an aperture or bore therethrough.
Compress mixture to a pressure of 3000 psi with 52 t
Remove block out of mold.

It will be appreciated that features from one embodiment may be appropriately incorporated into another embodiment unless technically unfeasible to do so.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An animal foodstuff comprising,
forage combined with an edible binder to give a block of forage based edible material; and
associating the block of forage based edible material with an elongate hanging element, such that at least a portion of the elongate hanging element is associated with the block of forage based edible material in a manner that permits suspension of said block of forage based edible material from a suitable suspension point.

2. An animal foodstuff as in claim 1, further comprising;
an elongate hanging element, at least a portion of which is associated with the block of forage based edible material in a manner that permits suspension of said block of forage based edible material from a suitable suspension point.

3. An animal foodstuff as in claim 1, wherein the animal foodstuff is a domesticated animal foodstuffs.

4. An animal foodstuff as in claim 1, wherein the animal foodstuff is an equine foodstuff.

5. An animal foodstuff as in claim 1, wherein the binder is a lignin-based binder.

6. An animal foodstuff as in claim 5, wherein the binder is lignin sulfonate and present between 5% and 20%.

7.-8. (canceled)

9. An animal foodstuff as in claim 1, wherein the block of forage based edible material has rounded outer edges or is cylindrical in shape with at least one end of the cylinder being substantially domed.

10.-11. (canceled)

12. An animal foodstuff recited in claim 1, wherein the elongate hanging element extends through the block of forage based edible material and is secured at least at one end.

13. An animal foodstuff as recite in claim 1, wherein the block of forage based edible material is provided with a through bore through which the elongate hanging element may pass.

14. An animal foodstuff as in claim 13 wherein the elongate hanging element is provided with a stop means at one end that is unable to pass through the through-bore.

15. (canceled)

16. An animal foodstuff as recited in claim 1, wherein one end of the elongate hanging element is embedded in a substantially solid block of forage based edible material.

17. An animal foodstuff as recited in claim 1, wherein the elongate hanging element is a rope.

18. A method of manufacturing an animal foodstuff in a form of a block of forage based edible material comprising;
providing an edible binder in liquid form;
adding said binder substantially uniformly to a forage material such that it is substantially evenly distributed throughout the forage; and
compressing the material into a desired shape to give a block of forage based edible material,
wherein after the material has been compressed into a desired shape, an aperture of an appropriate size to receive an elongate hanging element is created in the block of forage based edible material,
an elongate hanging element is then passed through the aperture such that the block of forage based edible material can be suspended via the elongate hanging element.

19.-25. (canceled)

26. A method of manufacturing an animal foodstuff in a form of a block of forage based edible material comprising:
providing an edible binder in liquid form;
adding said binder of substantially uniformly to a forage material such that it is substantially evenly distributed throughout the forage; and
compressing the material into a desired shape to give a block of forage based edible material,
wherein before the material has been compressed into desired shape, or during compression of the material, an elongate hanging element is embedded into the forage such that a portion is within the material and a portion extends therefrom.

27. A method of manufacturing as in claim 26, wherein the binder is present in quantities between 5% and 15%.

28. A method of manufacturing as in claim 26, wherein the binder is present at 10%.

29. A method of manufacturing as in claim 26, wherein compression of the material during the compressing operation occurs in a shaped mold.

30.-32. (canceled)
